(19) United States
(12) Patent Application Publication
(10) Pub. No.: US 2026/0330652 A1
(43) Pub. Date: Oct. 22, 2026

(54) Field of View Change Detection for Camera Systems

(71) Applicant: ServiceNow, Inc., Santa Clara, CA (US)

(72) Inventors: Mohamed Abouelela Abdou Abdallah Mohamed, Port Said (EG); Mahmoud Aboelsoud Said Ahmed Shousha, Kafrelsheikh (EG)

(21) Appl. No.: 19/185,380

(22) Filed: Apr. 22, 2025

(51) Int. Cl. G06T 7/246; G06V 10/25

(52) U.S. Cl. CPC G06T 7/246; G06V 10/25; G06T 2207/10016

(57) ABSTRACT

A method includes obtaining first image data from a camera capturing a physical environment from a first field of view (FOV) and obtaining second image data from the camera capturing the physical environment from a second FOV. The method includes determining a first plurality of keypoints based on the first image data and determining a second plurality of keypoints based on the second image data. The method includes determining movement of corresponding keypoints between the first image data and the second image data and generating a change indicator indicating a change between the first plurality of keypoints and the second plurality of keypoints.

### TECHNICAL FIELD

This disclosure relates to field of view change detection.

### BACKGROUND

A wide range of applications, spanning security, surveillance, and automated process control, use camera-based monitoring systems. A camera-based monitoring system often employs sophisticated algorithms to extract meaningful information from the visual data provided by the camera. The accuracy and reliability of these algorithms are fundamentally dependent on a consistent and stable camera field of view (FOV). The FOV defines the observable scene captured by the camera, and any unintended movement, such as panning, tilting, or rotating, even a slight vibration or a subtle shift in the mounting of the camera, may alter this view. This alteration introduces a discrepancy between the expected scene composition and the actual image data received. This discrepancy may manifest as a false positive or negative in a detection system, misinterpretation of object position or activity, and ultimately, a flawed output from any system relying on the integrity of the image captured by the camera.

### SUMMARY

One implementation of the disclosure provides a computer-implemented method of field of view change detection in camera systems. The method includes obtaining first image data from a camera capturing a physical environment from a first field of view (FOV) and obtaining second image data from the camera capturing the physical environment from a second FOV. In some examples, the method includes dividing the first image data and the second image data into regions of interest (ROIs) and selects four corner ROIs of each image or other designated ROIs to minimize noise in the central area of the physical environment caused by object movements. Dividing the image data into ROIs helps reduce and prevent false alarms and increases accuracy. The method includes determining a first plurality of keypoints based on the first image data and determining a second plurality of keypoints based on the second image data. The method includes determining movement of corresponding keypoints between the first image data and the second image data and generating a change indicator indicating a change between the first plurality of keypoints and the second plurality of keypoints.

Implementations of the disclosure may include one or more of the following optional features. In some implementations, the method further includes identifying a first region of interest (ROI) based on the first image data and identifying a second ROI based on the second image data. The first ROI corresponds to the second ROI. Here, determining the first plurality of keypoints may be further based on the first ROI and determining the second plurality of keypoints is further based on the second ROI. In these implementations, identifying the first ROI may include identifying four corner regions of the first image based on the first image data and identifying the second ROI includes identifying four corner regions of the second image based on the second image data. Each corner region of the first image corresponds to a respective corner region of the second image. The method may further include converting the first ROI into first grayscale image data and converting the second ROI into second grayscale image data. Here, determining the first plurality of keypoints may be further based on the first grayscale image data and determining the second plurality of keypoints is further based on the second grayscale image.

In some examples, the method further includes matching the first plurality of keypoints within the first image data to the second plurality of keypoints within the second image data and identifying the corresponding keypoints between the first image data and the second image data based on matching the first plurality of keypoints within the first image data to the second plurality of keypoints within the second image data. The method may further include adjusting an operational parameter of the camera based on the change indicator. In some implementations, the method further includes processing the second image data or subsequently captured image data based on the change indicator. In some implementations, the method further includes determining a Euclidean distance between the corresponding keypoints. In these implementations, determining the movement of the corresponding keypoints comprises determining that the Euclidean distance satisfies a distance threshold.

Determining the movement may include determining that a number of keypoints moved between the first image data and the second image data satisfies a keypoint threshold. In some examples, the method further includes processing, using an image processing model, a predetermined area within each image captured by the camera. In these examples, the method may further include adjusting the predetermined area within the second image data based on the change indicator. Determining the movement of the corresponding keypoints between the first image data and the second image data may include determining the movement agnostic to any movement information from the camera. In some implementations, each keypoint of the corresponding keypoints includes a feature identifiable in both the first image data and the second image data. Determining the first plurality of keypoints and the second plurality of keypoints may include using the Oriented FAST and the Rotated BRIEF (ORB) algorithm. In some examples, the first image data represents a first image of the physical environment and the second image data represents a second image of the physical environment.

Another implementation of the disclosure provides a system that includes data processing hardware and memory hardware storing instructions that when executed on the data processing hardware causes the data processing hardware to perform operations. The operations include obtaining first image data from a camera capturing a physical environment from a first field of view (FOV) and obtaining second image data from the camera capturing the physical environment from a second FOV. The operations include determining a first plurality of keypoints based on the first image data and determining a second plurality of keypoints based on the second image data. The operations include determining movement of corresponding keypoints between the first image data and the second image data and generating a change indicator indicating a change between the first plurality of keypoints and the second plurality of keypoints.

Another implementation of the disclosure provides a computer-readable medium having instructions that, when executed by data processing hardware, causes the data processing hardware to perform operations. The operations include obtaining first image data from a camera capturing a physical environment from a first field of view (FOV) and obtaining second image data from the camera capturing the physical environment from a second FOV. The operations include determining a first plurality of keypoints based on the first image data and determining a second plurality of keypoints based on the second image data. The operations include determining movement of corresponding keypoints between the first image data and the second image data and generating a change indicator indicating a change between the first plurality of keypoints and the second plurality of keypoints.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1 is a schematic view of an example system executing a camera controller.

FIGS. 2A-2C are schematic views of example images captured by a camera.

FIG. 3 is a schematic view of an example detector of the camera controller.

FIG. 4 is a flowchart of an example arrangement of operations for a computer-implemented method of field of view change detection in camera systems.

FIG. 5 is a schematic view of an example computing device that may be used to implement the systems and methods described herein.

Like reference symbols in the various drawings indicate like elements.

### DETAILED DESCRIPTION

The stability of a field of view (FOV) of a camera is essential in ensuring the accuracy and reliability of a camera-based monitoring system. A wide range of applications, such as security, surveillance, and automated process control, use camera-based monitoring systems. However, maintaining a constant FOV in real-world conditions presents a significant challenge. Unintentional movement of a camera, often caused by an external factor, degrades downstream applications that rely on that image data. The result of this degradation includes system failures such as an increased error rate and a reduction in system accuracy. Distinguishing between genuine scene changes and apparent changes caused by motion of the camera becomes even more difficult. Some approaches involve a complex sensor system, such as a gyroscope, to detect camera movement. However, this approach requires additional hardware, is more expensive, and introduces a delay that is impractical for a real-time application. Another approach includes using a machine learning model which results in reduced accuracy and significantly more latency. Moreover, the machine learning model approach may be expensive and require specialized hardware, such as a graphics processing unit (GPU) card, to achieve even this level of performance.

To that end, implementations herein are directed toward a camera controller that obtains a first image and a second image from a camera. The camera controller identifies one or more regions of interest (ROIs) within the first image and the second image. Each ROI in the first image corresponds to a respective ROI in the second image. The camera controller determines a first plurality of keypoints based on the first image data and a second plurality of keypoints based on the second image data. The camera controller determines movement of corresponding keypoints between the first image data and the second image data and generates a change indicator indicating a change between the first plurality of keypoints and the second plurality of keypoints.

Advantageously, the camera controller detects changes in FOV with improved computational efficiency and reduced latency. In particular, the camera controller may execute entirely on a central processing unit (CPU), thereby eliminating the need for a GPU or other specialized hardware. Moreover, the camera controller achieves this performance without requiring any additional sensor data from the camera itself, such as a gyroscope or an accelerometer. The camera controller provides enhanced accuracy in detecting real camera movement by analyzing the movement of corresponding keypoints within pre-defined ROIs, making the camera controller less susceptible to false positives from minor scene changes or lighting variations. Using ROIs allows a focus on stable, distinctive features, and comparing corresponding keypoints between images provides a direct measurement of image shift (e.g., a proxy for camera movement), improving accuracy in distinguishing camera-specific motion from background changes.

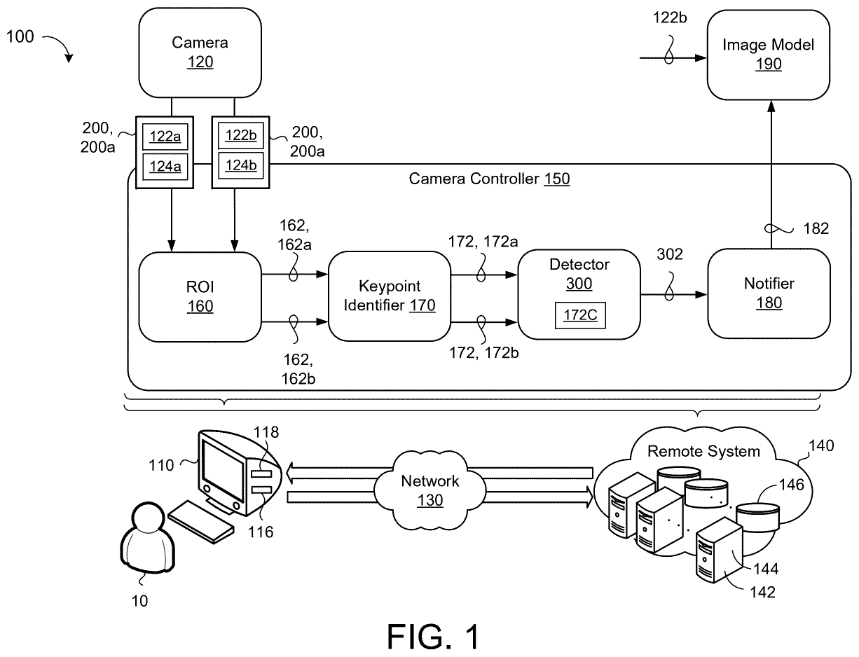

Referring to FIG. 1, in some implementations, a system 100 includes a remote system 140 in communication with one or more user devices 110 each associated with a respective user 10 via a network 130, such as the Internet, a local area network (LAN), a wide area network (WAN), a cellular network, or a wireless network. The remote system (i.e., distributed computing system) 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via, for example, the network 130.

The user device(s) 110 may correspond to any computing device, such as a desktop workstation, a laptop workstation, or a mobile device (i.e., a smartphone). Each user device 110 includes computing resources 116 (e.g., data processing hardware) and/or storage resources 118 (e.g., memory hardware). The data processing hardware 116 executes a graphical user interface (GUI) for display on a screen in communication with the data processing hardware 116. The GUI may be provided by a web browser, a web application, a native application, or a hybrid application running on the user device 110.

The remote system 140 and/or user device executes a camera controller 150, which may reside entirely on the remote system 140 for centralized processing, entirely on the user device 110 for local control, or be distributed across both. The camera controller 150 communicates with a camera 120. The camera 120 may be any camera and may be any type of image capture device, such as, but not limited to, a standard webcam, a security surveillance camera, an industrial machine vision camera, or the camera integrated into a mobile device (e.g., the user device 110). The camera 120 is configured to capture images 200 of a physical environment, for example, an indoor space such as an office or factory floor, or an outdoor scene. The camera controller 150 may receive the images 200, with each image 200 corresponding to a particular field of view (FOV) 122 (i.e., the angular extent of the scene captured by the camera 120 at a given moment) and including image data 124. In the example shown in FIG. 1, only one camera 120 is shown for simplicity, however, the system 100 may include a plurality of cameras 120 without departing from the scope of the present disclosure.

The camera controller 150 includes a region of interest (ROI) module 160, a keypoint identifier 170, a detector 300, and a notifier 180. The ROI module 160 obtains a first image 200, 200a from the camera 120 capturing the physical environment from a first FOV 122, 122a, and subsequently obtains a second image 200, 200b from the same camera 120 capturing the physical environment from what is presumed or intended to be the same physical viewpoint, resulting in a second FOV 122, 122b. The first image 200a may include first image data 124, 124a and represent a desired or configured view of the camera 120. For instance, the first image 200a may be captured during an initial setup or calibration phase, serving as a baseline. The second image 200b may include second image data 124, 124b and represent a subsequent image 200 captured by the camera 120 after the first image 200a.

In some examples, the first image data 124a represents a first image frame captured at a first time (e.g., time t1) and the second image data 124b represents a second image frame captured at a second time (e.g., time t2) subsequent to the first time, such as consecutive frames in a video stream or images captured periodically for monitoring. This scenario arises frequently in applications such as video surveillance, where the images 200 are consecutive frames in a video stream, or in periodic monitoring systems where images 200 may be captured, for instance, every minute or every hour. Notably, the camera controller 150 determines whether the first FOV 122a is the same or different from the second FOV 122b by analyzing how features within specific, predefined regions appear to shift between two images. For instance, the camera controller 150 may analyze changes within specific regions of the first image data 124a and the second image data 124b to infer if the camera 120 itself has moved due to factors like vibration, accidental bumps, or gradual mounting slippage.

The ROI module 160 identifies at least one first ROI 162, 162a based on the first image data 124a and identifies at least one second ROI 162, 162b based on the second image data 124b. An ROI 162 is essentially a sub-region within an image designated for specific processing, effectively focusing computational resources and analysis on areas that are expected to include stable and informative features relative to the perspective of the camera 120. As such, each ROI 162 may represent a corresponding portion of the image data. By concentrating on these ROIs 162, the camera controller 150 more efficiently and reliably detects shifts caused by camera 120 movement as opposed to changes occurring within the broader scene. For instance, an ROI 162 may be defined to encompass a corner of a stationary cabinet and the adjacent wall texture within an office scene. Here, the ROI 162 intentionally excludes areas where people walk or where transient shadows may appear. Analyzing only selected ROIs 162 avoids processing large, potentially dynamic areas of the scene (e.g., moving people or changing lighting) that could otherwise confuse the motion analysis, while also reducing the computational resource consumption compared to analyzing the entire image frame.

The first ROI 162a corresponds to the same portion of the physical environment as the second ROI 162b, assuming no camera 120 movement has occurred between the capture of the first image data 124a and the second image data 124b. Both the first ROI 162a and the second ROI 162b are defined by fixed coordinates relative to their respective image frames (e.g., a rectangle defined from pixel coordinate (x1, y1) to (x2, y2)) within the image boundaries. Therefore, if the camera 120 remains perfectly still, the same physical features will appear within these fixed image frame coordinates. On the other hand, the first ROI 162a corresponds to a different portion of the physical environment from the second ROI 162b when movement of the camera 120 has occurred between the capture of the first image data 124a and the second image data 124b. That is, the location and size of the second ROI 162b are defined relative to the image frame (e.g., by specific pixel coordinates defining its boundaries) in the same way the first ROI 162a is defined relative to its image frame, with the intent that both ROIs 162 should capture the identical portion of the physical environment if the FOV of the camera remains unchanged. Any shift in the content within these identically defined ROIs between the two images may thus be interpreted as potential camera 120 movement.

In some examples, the ROI module 160 identifies the at least one first ROI 162a by identifying four corner regions of the first image based on the first image data 124a and identifies the corresponding at least one second ROI 162b by identifying four corner regions of the second image based on the second image data 124b. Here, each corner region represents a respective ROI 162. For instance, each corner ROI 162 may be defined as square area of a predetermined size (e.g., 50×50 pixels) located at each of the corners of the image frame (e.g., in an image with width W, the top-left ROI 162 spans pixels (0,0) to (49, 49), the top-right ROI 162 spans (W-50, 0) to (W-1, 49), and so on).

Using corner regions is advantageous for detecting global shifts or rotations of the FOV, as corner regions typically include distinct features (e.g., intersections of edges, high contrast areas where scene elements meet the image boundary) resulting from the intersection of image boundaries with scene content, and these regions are less prone to occlusion by foreground objects compared to central areas of the image 200. Movement detected consistently across these spatially distributed corner ROIs 162 is a strong indicator of overall camera 120 displacement or rotation. As such, each corner region defined in the first image corresponds to a respective corner region defined in the second image based on the fixed pixel coordinate positions within the image frame. Moreover, using the four corner regions of the image data 124 minimizes the noise in the central area of the physical environment (e.g., center region of the image) caused by normal movement of objects within the physical environment.

In other examples, an ROI 162 may be defined by the user 10 or another process to encompass a specific static object within the physical environment, such as a specific marking on a wall, a piece of stationary equipment in an industrial setting (e.g., a pressure gauge, a control panel), or a distant landmark in an outdoor surveillance scenario (e.g., a specific tree, a building corner, a mountain peak). Such object-based ROIs 162 are chosen because the object itself is not expected to move relative to the physical environment, making any apparent shift of the object within the ROI 162 likely due to camera 120 movement. Alternatively, the camera controller 150 may use an automated process to analyze an initial reference image 200 to identify regions with high texture or numerous corner-like features that are likely to be static and suitable for defining ROIs 162. In some implementations, the ROI module 160 converts the first ROI 162a into first grayscale image data and converts the second ROI 162b into second grayscale image data. Converting to grayscale simplifies subsequent processing by removing color information, reducing computational complexity and making the keypoint 172 detection less sensitive to variations in lighting color.

The keypoint identifier 170 determines or identifies a first plurality of keypoints 172, 172a based on the first image data 124a within the first ROIs 162a, and similarly determines a second plurality of keypoints 172, 172b based on the second image data 124b within the corresponding second ROIs 162b. In some examples, the keypoint identifier 170 identifies the first plurality of keypoints 172a and the second plurality of keypoints 172b based on the first grayscale image data and the second grayscale image data in addition to, or in lieu of, the first ROI 162a and the second ROI 162b. Keypoints 172 represent specific points in an image 200 that are salient or distinctive, often corresponding to features such as corners, edges, or regions with high contrast or unique texture patterns that may be reliably detected across different images 200 even with changes in FOV, scale, or lighting. For example, within a corner ROI 162, a keypoint 172 may be the intersection of two lines forming the corner of a distant building visible in the image 200, or a unique texture pattern on a wall segment captured within that ROI 162.

In some implementations, the keypoint identifier 170 uses an algorithm such as the Oriented FAST and Rotated BRIEF (ORB) algorithm to identify the keypoints 172 and determine associated descriptors (e.g., feature vectors). A descriptor or feature vector is a numerical vector that uniquely characterizes the appearance of the image patch surrounding a keypoint 172, allowing keypoints corresponding to the same physical feature to be matched between the first and second images 200. The ORB algorithm is computationally efficient, combining FAST keypoint detection with BRIEF descriptors, modified for rotation and scale invariance, making the ORB algorithm suitable for real-time CPU-based processing. Other feature detection and description algorithms, for example, SIFT (Scale-Invariant Feature Transform) or SURF (Speeded Up Robust Features) may also be employed, potentially offering different trade-offs between accuracy, robustness, and computational cost.

The detector 300 determines movement 302 of corresponding keypoints 172 between the first image data 124a and the second image data 124b. The detector 300 determines the movement 302 by establishing which keypoints 172 in the first image 200a correspond to which keypoints in the second image 200b and then analyzes the distance between these matched pairs. Notably, the detector 300 determines the movement 302 of the corresponding keypoints 172 between the first image data 124a and the second image data 124b agnostic to any movement information from the camera 120 itself. That is, the camera 120 may not have any internal sensors such as gyroscopes or accelerometers capable of capturing movement information of the camera 120.

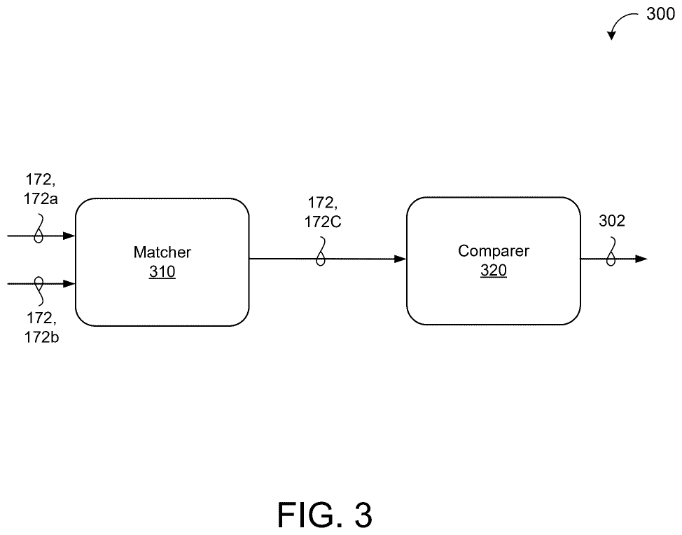

Referring now to FIG. 3, in some implementations, the detector 300 includes a matcher 310 and a comparer 320. The matcher 310 is configured to match (i.e., establish correspondences between) the first plurality of keypoints 172a identified within the first ROIs 162a of the first image data 124a to the second plurality of keypoints 172b identified within the second ROIs 162b of the second image data 124b. The matcher 310 may match the keypoints 172 by comparing descriptors associated with each keypoint 172, which numerically encodes the visual characteristics of the image region around the keypoint 172. That is, the matcher 310 searches for pairs of keypoints 172, one from the first plurality of keypoints 172a and one from the second plurality of keypoints 172b, whose descriptors are highly similar according to a distance metric. Common metrics include the Hamming distance for binary descriptors such as ORB or BRIEF, or the Euclidean distance (L2 norm) for vector descriptors such as SIFT or SURF. This similarity indicates that the keypoints 172 likely represent the same physical feature observed in both images 200a, 200b, even if the pixel coordinates of the feature have shifted between the images 200a, 200b due to movement of the camera 120.

To that end, the matcher 310 identifies a set of matched pairs, referred to herein as corresponding keypoints 172, 172C, between the first image data 124a and the second image data 124b. Each pair within the set of corresponding keypoints 172C includes one keypoint 172 from the first image 200a and the corresponding keypoint 172 in the second image 200b, representing a feature identifiable in both the first image data 124a and the second image data 124b. That is, each keypoint 172 of the corresponding keypoints 172C may include a feature identifiable in both the first image data 124a and the second image data 124b. For instance, if a keypoint 172 representing the sharp corner of a specific marking on a wall is detected in the first ROI 162a and has a particular ORB descriptor, the matcher 310 will search for a keypoint 172 in the corresponding second ROI 162b that has the most similar ORB descriptor (i.e., the smallest Hamming distance). If a corresponding keypoint 172 is found and the distance is below a certain matching threshold, these two keypoints 172 form a pair included in the set of corresponding keypoints 172C.

The comparer 320 receives the set of corresponding keypoints 172C and analyzes the spatial displacement between the keypoints 172 within each pair to infer movement 302 of the camera 120. Specifically, for each pair of corresponding keypoints 172C, where the keypoint 172a from the first image 200a is at pixel coordinates (x1, y1) and the corresponding keypoint 172b from the second image 200b is at pixel coordinates (x2, y2), the comparer 320 determines a Euclidean distance 322 between the pixel coordinates. The comparer 320 then aggregates these individual displacement measurements to determine whether movement 302 occurred between the first image 200a and the second image 200b based on the distances 322. In some examples, the comparer 320 determines that movement 302 indicative of a FOV shift has occurred by determining that the Euclidean distance 322 for a threshold number of corresponding keypoint pairs 172C satisfies a distance threshold. For instance, if the distance threshold is set to 3 pixels (e.g., representing an acceptable tolerance for minor jitter or noise), and 12 the comparer 320 determines that more than the threshold number of corresponding keypoint pairs 172C have a Euclidean distance 322 greater than 3 pixels, the comparer may determine movement between the first image 200a and the second image 200b.

Referring back to FIG. 1, based on the determination made by the comparer 320 regarding whether movement 302 has occurred, the notifier 180 generates a change indicator 182 indicating whether a significant change (e.g., interpreted as FOV movement) was detected between the first plurality of keypoints 172a and the second plurality of keypoints 172b. The change indicator 182 may be, for example, a Boolean value (e.g., true/false), a status code, or a quantitative value representing the degree or confidence of the detected movement. Based on the change indicator 182, the camera controller may adjust one or more operational parameters of the camera 120 (e.g., triggering a re-calibration if possible), issuing an alert to an operator, or logging an event indicating potential camera 120 misalignment or tampering.

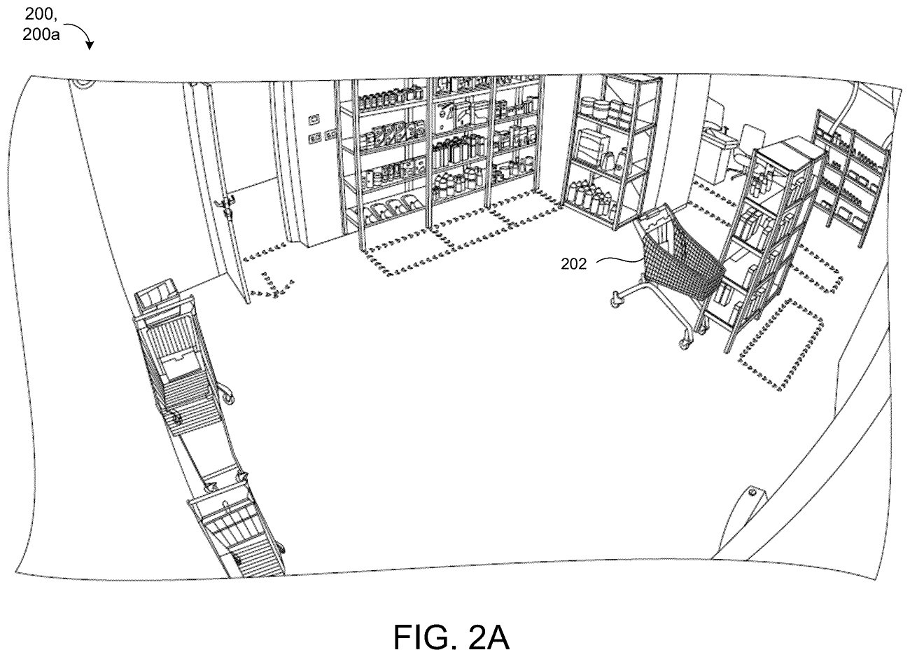

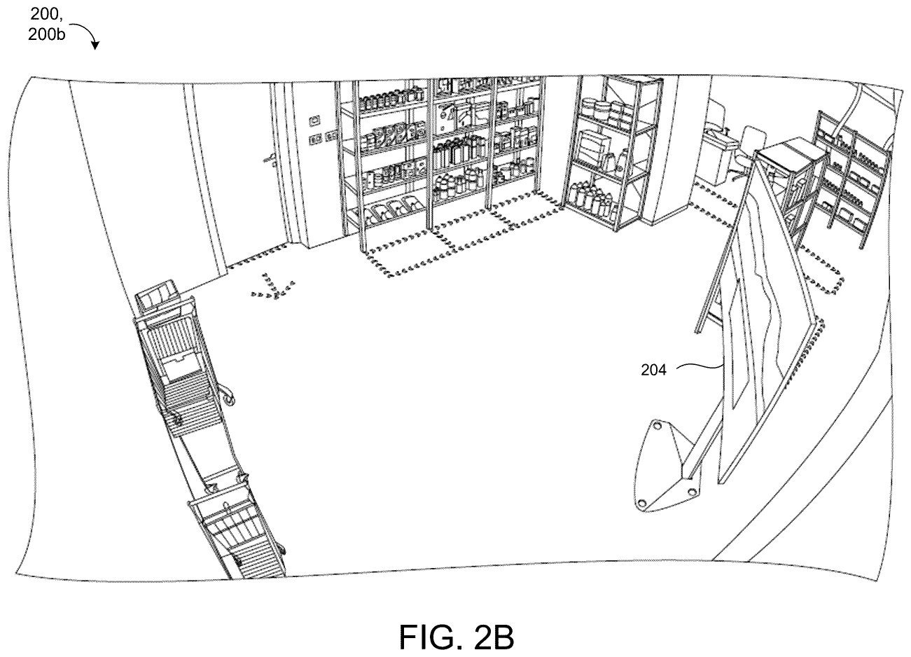

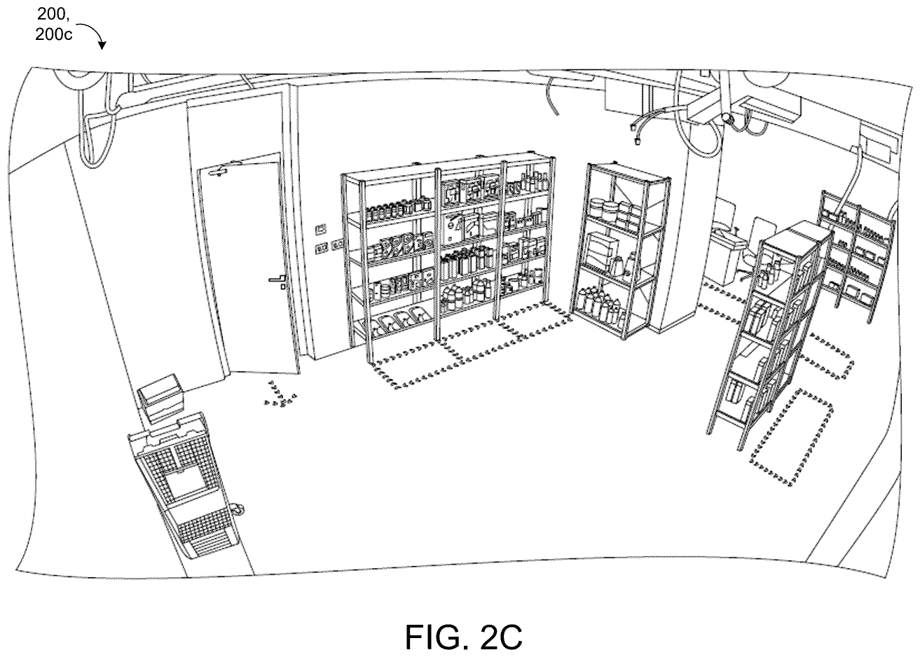

FIGS. 2A-2C illustrate example images 200. For instance, FIG. 2A may represent the first image 200a capturing a scene at a first FOV 122a, which serves as the intended or reference configuration for the camera 120. Notably, FIG. 2A illustrates a shopping cart 202 alongside background elements. FIG. 2B represents the second image 200b at the second FOV 122b captured by the same camera 120 after the first image 200a. In the second image 200b, the shopping cart 202 has been replaced with a display board 204. Regardless, despite this change in the foreground content of the scene, the underlying perspective or viewpoint of the camera 120 has not changed, thus, the second FOV 122b is the same as the first FOV 122a. As such, the camera controller 150 would determine that no significant movement 302 has occurred between the first image 200a (FIG. 2A) and the second image 200b (FIG. 2B). This determination relies on the analysis within the predefined ROIs 162. Therefore, even though the shopping cart 202 was replaced by the display board 204 (e.g., a significant scene change), the camera controller 150 correctly identifies that the FOV of the camera 120 has remained the same.

In contrast, FIG. 2C illustrates a third image 200c where the camera has physically moved or tilted relative to the scene (e.g., due to vibration, an impact, or mounting slippage), and the scene does not include the shopping cart 202 nor the display board 204. As a result, the third image 200c captures a third FOV that is different from the first FOV and the second FOV. Visually, this results in a shift of the background elements relative to the image frame, for example, the horizon line may appear higher or lower. Notably, the absence of the shopping cart 202 and the display board 204 in FIG. 2C is incidental to the FOV change detection. As such, the camera controller 150 would determine that significant movement 302 has occurred between the first image 200a (or the second image 200b) with the third image 200c. This determination occurs because the keypoints 172 within the corresponding ROIs (e.g., comparing keypoints 172a from the first ROIs 162a in FIG. 2A against keypoints 172c from corresponding ROIs 162c derived from image 200c) would exhibit a substantial and consistent shift in their pixel coordinates due to the changed camera perspective. The matcher 310 may still find corresponding keypoints 172C representing the same static background features, but the comparer 320 would calculate significant Euclidean distances 322 between many of these pairs.

Referring back to FIG. 1, an image processing model 190 may receive the change indicator 182 and process the second image data 124b or subsequent image data 124b based on the change indicator 182. In some implementations, the image processing model 190 is configured to process a predetermined area within each image data 124 captured by the camera. The predetermined area may be different from the ROI 162, for example, a center of the image. Accordingly, the image processing model 190 may adjust the predetermined area within the second image data 124b based on the change indicator 182 to account for the movement of the camera 120.

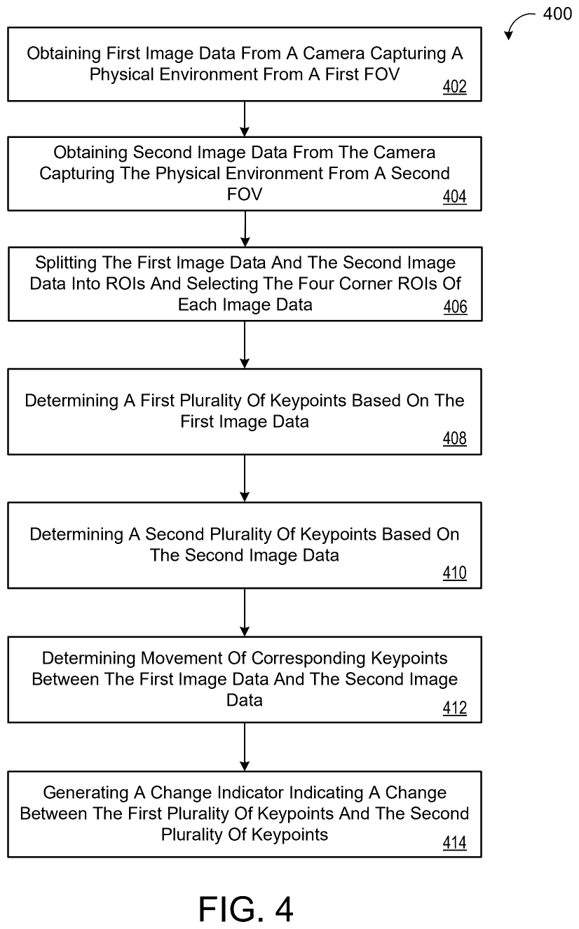

FIG. 4 is a flowchart of an exemplary arrangement of operations for a computer-implemented method 400 of performing field of view change detection in camera systems. At operation 402, the method 400 includes obtaining first image data 124a from a camera 120 capturing a physical environment from a first FOV 122a. At operation 404, the method 400 includes obtaining second image data 124b from the camera 120 capturing the physical environment from a second FOV 122b. In some examples, the method 400, at operation 406, includes splitting the first image data 124a and the second image data 124b into ROIs 162 and selecting the four corner ROIs 162 of the first image data 124a and the second image data 124b. In other examples, the method 400 does not include operation 406. At operation 408, the method 400 includes determining a first plurality of keypoints 172a based on the first image data 124a. At operation 410, the method 400 includes determining a second plurality of keypoints 172b based on the second image data 124b. At operation 412, the method 400 includes determining movement 302 of corresponding keypoints 172C between the first image data 124a and the second image data 124b. At operation 414, the method 400 includes generating a change indicator 182 indicating a change between the first plurality of keypoints 172a and the second plurality of keypoints 172b.

The camera controller 150 provides a significant technical improvement over conventional methods by reducing the computational resources required for reliable FOV change detection. By strategically employing ROIs 162, the camera controller 150 avoids processing the entire image frame, focusing computation only on specific, stable areas. Moreover, the utilization of computationally efficient algorithms such as ORB for keypoint 172 detection and matching, combined with direct Euclidean distance 322 comparison, allows the entire process to execute effectively on standard CPU hardware, eliminating the need for costly and power-intensive specialized hardware such as GPUs or dedicated sensors (e.g., gyroscopes). This reduction in processing load translates directly to lower latency, enabling real-time detection critical for many monitoring applications, and reduces the overall system cost and complexity.

Importantly, these technical advantages are achieved through a specific, practical implementation. The camera controller 150 provides a concrete solution to the technical problem of efficiently and accurately detecting camera FOV changes, particularly beneficial in resource-constrained environments. The specific steps of defining ROIs 162, extracting keypoints 172 within those ROIs 162 using defined algorithms (e.g., ORB), matching keypoints 172 based on descriptors, and quantifying movement based on Euclidean distance 322 collectively improve the functioning of the camera monitoring system itself. This targeted approach yields tangible benefits such as reduced hardware requirements, lower power consumption, and faster response times, demonstrating a specific improvement in the operation and efficiency of the computer-based monitoring system.

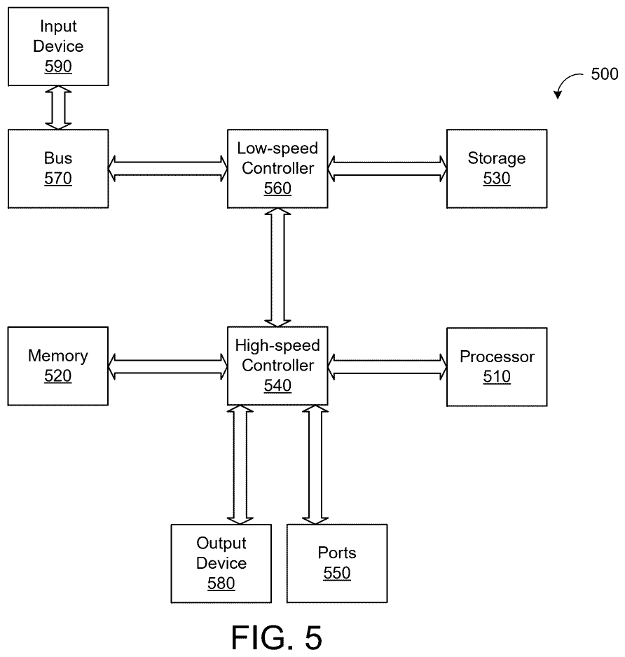

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a 17 pointing device, a microphone, a touch screen, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer.

Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining first image data from a camera capturing a physical environment from a first field of view (FOV);
obtaining second image data from the camera capturing the physical environment from a second FOV;
determining a first plurality of keypoints based on the first image data;
determining a second plurality of keypoints based on the second image data; and
determining movement of corresponding keypoints between the first image data and the second image data; and
generating a change indicator indicating a change between the first plurality of keypoints and the second plurality of keypoints.

2. The method of claim 1, further comprising:
identifying a first region of interest (ROI) based on the first image data; and
identifying a second ROI based on the second image data, the first ROI corresponding to the second ROI.

3. The method of claim 2, wherein:
determining the first plurality of keypoints is further based on the first ROI; and
determining the second plurality of keypoints further based on the second ROI.

4. The method of claim 2, wherein:
identifying the first ROI comprises identifying four corner regions of a first image based on the first image data; and
identifying the second ROI comprises identifying four corner regions of a second image based on the second image data, each corner region of the first image corresponding to a respective corner region of the second image.

5. The method of claim 2, further comprising:
converting the first ROI into first grayscale image data; and
converting the second ROI into second grayscale image data.

6. The method of claim 5, wherein:
determining the first plurality of keypoints is further based on the first grayscale image data; and
determining the second plurality of keypoints is further based on the second grayscale image.

7. The method of claim 1, further comprising:
matching the first plurality of keypoints within the first image data to the second plurality of keypoints within the second image data; and
based on matching the first plurality of keypoints within the first image data to the second plurality of keypoints within the second image data, identifying the corresponding keypoints between the first image data and the second image data.

8. The method of claim 1, further comprising adjusting an operational parameter of the camera based on the change indicator.

9. The method of claim 1, further comprising processing the second image data or subsequently captured image data based on the change indicator.

10. The method of claim 1, further comprising determining a Euclidean distance between the corresponding keypoints.

11. The method of claim 10, wherein determining the movement of the corresponding keypoints comprises determining that the Euclidean distance satisfies a distance threshold.

12. The method of claim 1, wherein determining the movement comprises determining that a number of keypoints moved between the first image data and the second image data satisfies a keypoint threshold.

13. The method of claim 1, further comprising processing, using an image processing model, a predetermined area within each image data captured by the camera.

14. The method of claim 13, further comprising adjusting the predetermined area within the second image data based on the change indicator.

15. The method of claim 1, wherein determining the movement of the corresponding keypoints between the first image data and the second image data comprises determining the movement agnostic to any movement information from the camera.

16. The method of claim 1, wherein each keypoint of the corresponding keypoints comprises a feature identifiable in both the first image data and the second image data.

17. The method of claim 1, wherein determining the first plurality of keypoints and the second plurality of keypoints comprises using the Oriented FAST and the Rotated BRIEF (ORB) algorithm.

18. The method of claim 1, wherein:
the first image data represents a first image of the physical environment; and
the second image data represents a second image of the physical environment.

19. A system comprising:
data processing hardware; and
memory hardware in communication with the data processing hardware, the memory hardware storing instructions that when executed on the data processing hardware cause the data processing hardware to perform operations comprising:
obtaining first image data from a camera capturing a physical environment from a first field of view (FOV);
obtaining second image data from the camera capturing the physical environment from a second FOV;
determining a first plurality of keypoints based on the first image data;
determining a second plurality of keypoints based on the second image data; and
determining movement of corresponding keypoints between the first image data and the second image data; and
generating a change indicator indicating a change between the first plurality of keypoints and the second plurality of keypoints.

20. A computer-readable medium having instructions that, when executed by data processing hardware, causes the data processing hardware to perform operations comprising:
obtaining first image data from a camera capturing a physical environment from a first field of view (FOV);
obtaining second image data from the camera capturing the physical environment from a second FOV;
determining a first plurality of keypoints based on the first image data;
determining a second plurality of keypoints based on the second image data; and
determining movement of corresponding keypoints between the first image data and the second image data; and
generating a change indicator indicating a change between the first plurality of keypoints and the second plurality of keypoints.
